(19) United States
(12) Patent Application Publication
(10) Pub. No.: US 2022/0201553 A1
(43) Pub. Date: Jun. 23, 2022

(54) RADIO NETWORK NODE, NETWORK NODE AND METHODS PERFORMED THEREIN FOR CONTROLLING TRANSMISSION

(71) Applicant: Telefonaktiebolaget LM Ericsson (publ), Stockholm (SE)

(72) Inventors: Ralf Keller, Würselen (DE); Christer Gustafsson, Huddinge (SE); Afshin Abtin, Sollentuna (SE)

(21) Appl. No.: 17/599,644

(22) PCT Filed: Mar. 29, 2019
(86) PCT No.: PCT/SE2019/050291

§ 371 Date: Sep. 29, 2021

(51) Int. Cl. H04W 28/10; H04W 76/10

(52) U.S. Cl. CPC H04W 28/10; H04W 76/10

(57) ABSTRACT

Embodiments herein relates to a method performed by a network node for handling a communication session or one or more flows of the communication session in a wireless communication network. The network node transmits an indication to a radio network node at a session establishment of the communication session or of at least one flow of the communication session, wherein the indication indicates a category of the communication session or the at least one flow.

### TECHNICAL FIELD

Embodiments herein relate to a radio network node, a network node and methods performed therein regarding wireless communication. In particular, embodiments herein relate to handling a communication session or one or more flows of a communication session in a wireless communication network.

### BACKGROUND

In a typical wireless communications network, wireless devices, also known as wireless communication devices, mobile stations, stations (STA) and/or user equipment (UE), communicate via a Radio Access Network (RAN) with one or more core networks (CN). The RAN covers a geographical area which is divided into service areas or cell areas, with each service area or cell area being served by radio network node such as an access node e.g. a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the wireless devices within range of the radio network node. The radio network node communicates over a downlink (DL) to the wireless device and the wireless device communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 4G and 5G networks such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

3GPP RAN has defined a couple of scenarios as depicted in FIG. 1, for which work is either ongoing or planned. Note that option 1 is today's LTE/EPC network. As shown in FIG. 1 both LTE and NR may be connected to the NGCN i.e. 5GC. LTE may also connect to EPC partly to serve legacy UEs but also new UEs utilizing scenario 3 where NR is anchored in EPC/LTE (supported as an additional data carrier to LTE).

5GC architecture overview, including interworking to EPC, is shown in FIG. 2.

The RAN instructs the UE which neighbor cells to measure. The UE provides the measurement reports to the RAN and then RAN determines whether there is a need to perform handover to a cell of the same radio technology or to a cell of a different radio technology. Also Single Radio Voice Call Continuity (SRVCC) from LTE to 2G/3G is normally initiated by LTE eNB based on measurement reports.

The model in FIG. 2 enables that seamless interworking between the two LTE and NR, also referred to as next generation radio access network (NG-RAN), via procedures in EPC and 5GC which implies as example a voice call over NG-RAN/5GC can be moved to LTE/EPC when both access are voice capable. It implies though that voice quality of service (QoS) is supported on both radio accesses. When a voice call starts to be setup in a 5G system (5GS) but the media is established on EPC, the procedure to move the voice call from 5GS to EPS is known as EPS Fallback.

At one stage voice calls will be supported by both 5GC and 5G-RAN, hence the voice call will handled by the 5GS. If the voice needs any special treatment, for example positioning, it may still need to be moved to LTE using the EPS Fallback procedure.

It is currently not possible to identify the priority of a call that needs to be handled with e.g. EPS Fallback in a secure way. For example, an emergency call that needs positioning capabilities in the RAN, while supported by the 5G core (5GC) and IP Multimedia Subsystem (IMS), needs to be moved to LTE. The RAN has currently only two possibilities to identify the emergency call. First possibility is if the radio resource control (RRC) establishment cause refers to “emergency”, but this is only in the case when the UE is in idle state when the call is initiated. The second possibility is to base the decision on Allocation and retention priority (ARP) e.g. on ARP priority level relative another level for the voice flow. The ARP configuration is performed in the CN though, hence it requires consistent configuration in RAN to perform the correct decisions.

### SUMMARY

Further implications in using the ARP priority level for identification of emergency call is the simultaneous use of other priority services as national security and public safety (NSPS) and multimedia priority service (MPS) or wireless priority service (WPS).

The same problem exists both in 4G and 5G, while 5G is used herein to detail the information.

An object herein is to provide a mechanism to enable and handle a communication session or a flow in an efficient manner in a wireless communications network.

According to an aspect the object is achieved, according to embodiments herein, by providing a method performed by a network node for handling a communication session or one or more flows of the communication session in a wireless communication network. The network node transmits an indication to a radio network node at a session establishment of the communication session or of at least one flow of the communication session, wherein the indication indicates a category of the communication session or the at least one flow.

According to another aspect the object is achieved, according to embodiments herein, by providing a method performed by a radio network node for handling a communication session or one or more flows of the communication session in a wireless communication network. The radio network node receives an indication from a network node at a session establishment of the communication session or of at least one flow of the communication session, wherein the indication indicates a category of the communication session or the at least one flow. The radio network node handles the communication session or the at least one flow taking the indication into account.

It is furthermore provided herein a computer program product comprising instructions, which, when executed on at least one processor, cause the at least one processor to carry out the method above, as performed by the network node and the radio network node, respectively. It is additionally provided herein a computer-readable storage medium, having stored thereon a computer program product comprising instructions which, when executed on at least one processor, cause the at least one processor to carry out the method according to the methods above, as performed by the network node and the radio network node, respectively.

Embodiments herein provide an indication of the category at e.g. a flow establishment or call establishment. This will enable the radio network node e.g. 5G-RAN node, to make a correct decision regarding the needs e.g. of EPS or RAT Fallback and other mobility decisions. Moreover, in e.g. dual connectivity (DC) deployments in 5G, the radio network node is enabled to select a bearer, e.g. between bearers dependent on the category indicated. Embodiments herein provide a flow treatment such as an emergency or priority call treatment, based on category indicated, that will be optimized or secured in case of lacking capabilities, insufficient resources or operator preferences in the radio network node. Additionally, it would not require manual configuration in the radio network node and embodiments avoid risk for misalignment which may result in failed high priority calls.

### BRIEF DESCRIPTION OF THE DRAWINGS

Embodiments will now be described in more detail in relation to the enclosed drawings, in which:

FIG. 1 discloses different options of stand-alone and non-stand alone (NSA) setups;

FIG. 2 discloses schematic overview of architecture of LTE and NR;

FIG. 3 is a schematic overview depicting a wireless communications network according to embodiments herein;

FIG. 4a is a combined flowchart and signalling scheme according to some embodiments herein;

FIG. 4b is a schematic flowchart depicting a method performed by a first communication device according to embodiments herein;

FIG. 4c is a schematic flowchart depicting a method performed by a second communication device according to embodiments herein;

FIG. 5 is a combined flowchart and signalling scheme according to some embodiments herein;

FIG. 6a is a block diagram depicting a first communication device according to embodiments herein;

FIG. 6b is a block diagram depicting a second communication device according to embodiments herein;

FIG. 7 shows a telecommunication network connected via an intermediate network to a host computer in accordance with some embodiments;

FIG. 8 shows a host computer communicating via a base station with a user equipment over a partially wireless connection in accordance with some embodiments;

FIG. 9 shows methods implemented in a communication system including a host computer, a base station and a user equipment in accordance with some embodiments;

FIG. 10 shows methods implemented in a communication system including a host computer, a base station and a user equipment in accordance with some embodiments;

FIG. 11 shows methods implemented in a communication system including a host computer, a base station and a user equipment in accordance with some embodiments; and

FIG. 12 shows methods implemented in a communication system including a host computer, a base station and a user equipment in accordance with some embodiments.

### DETAILED DESCRIPTION

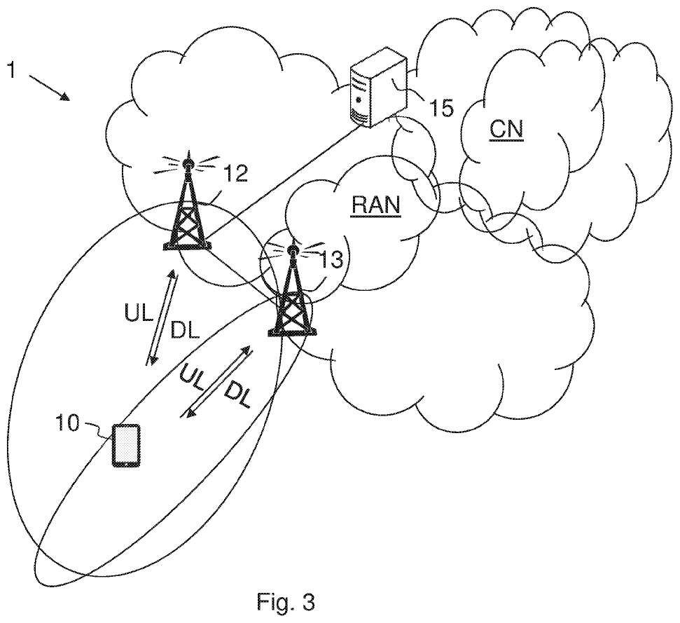

Embodiments herein relate to wireless communications networks in general. FIG. 3 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context and LTE, however, embodiments are also applicable in further development of existing wireless communications systems such as e.g. LTE or Wideband Code Division Multiple Access (WCDMA).

In the wireless communications network 1, a UE 10 such as a mobile station, a non-access point (non-AP) STA, a STA, a wireless device and/or a wireless terminal, is comprised communicating via e.g. one or more Access Networks (AN), e.g. RAN, to one or more core networks (CN). It should be understood by the skilled in the art that “wireless device” is a non-limiting term which means any terminal, wireless communications terminal, user equipment, NB-IoT device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a first radio network node 12 providing radio coverage over a geographical area, a first service area, of a first radio access technology (RAT), such as NR. The first radio network node, also denoted as the radio network node, may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage. Furthermore, a second radio network node 13 is comprised in the wireless communication network providing radio coverage over a geographical area, a second service area, of a second radio access technology (RAT), such as LTE. The second radio network node may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node depending e.g. on the second radio access technology and terminology used. The first RAT and the second RAT may be the same RAT or different RATs. The second radio network node may be referred to as a secondary serving radio network node wherein the service area may be referred to as a secondary serving cell, and the secondary serving radio network node communicates with the wireless device in form of DL transmissions to the wireless device and UL transmissions from the wireless device. It should be noted that a service area may be denoted as cell, beam, beam group or similar to define an area of radio coverage. As stated herein there may be two different CNs of different RATs such as 5GC and EPC implemented as well.

The wireless communications network 1 further comprises a network node 15 such as a mobility management entity (MME) or an AMF node e.g. for handling mobility of the UE 10 or similar. The network node 15 may be communicating with another network node 16 such as a session management function (SMF) node in case of NR or similar controlling data sessions in the wireless communication network 1.

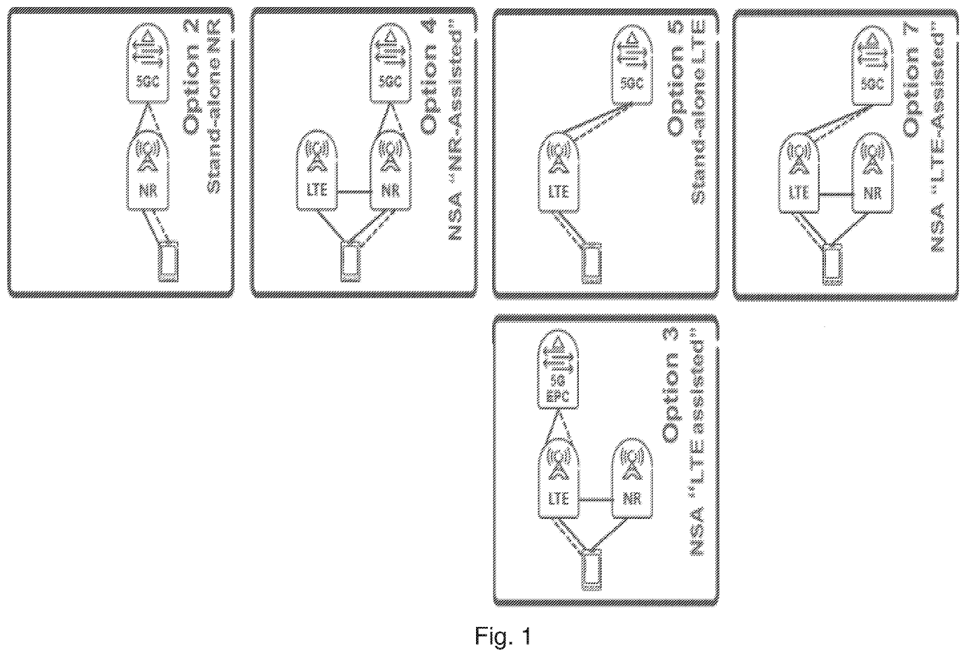

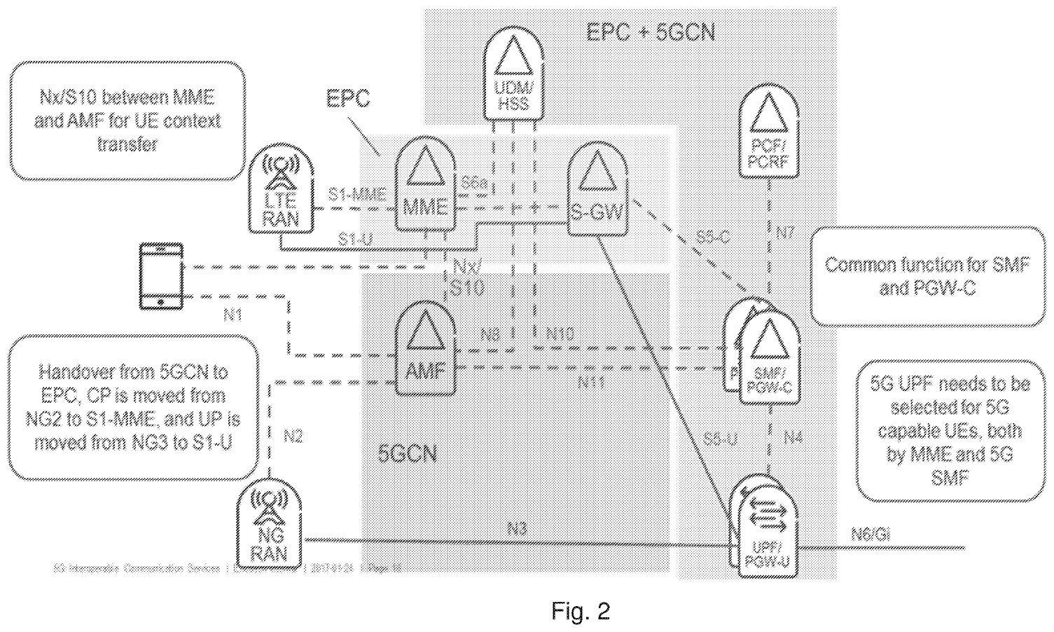

Embodiments herein are described within the context of 3GPP New radio (NR) radio technology, 3GPP TS 38.300 V15.2.0 (2018-06). It should be noted that the embodiments herein are equally applicable to wireless access networks and UEs implementing other access technologies and standards. NR is used as an example technology in the embodiments herein, and using NR in the description therefore is particularly useful for understanding the problem and solutions solving the problem. In particular, the embodiments herein are applicable also to 3GPP LTE, or 3GPP LTE and NR integration, also denoted as non-standalone NR (see FIG. 1).

For NR, the dual connectivity (DC) or multi-connectivity protocol architecture of a split bearer is specified, building on the protocol architecture used for LTE for the DC split bearer. In DC the UE is connected to two distinct radio nodes. The UE maintains a packet data convergence protocol (PDCP) entity for the split bearer connected to multiple (at least two) radio link control (RLC) and medium access control (MAC) entities, as well as physical layer entities (PHY). These are each associated to a cell group, the master cell group and secondary cell group respectively. Transmission via the master cell group goes to the master gNB (MgNB) or master eNB (MeNB) in LTE terminology, and transmission via the secondary cell group goes to the secondary gNB (SgNB) or secondary eNB (SeNB). MgNB and SgNB maintain their own RLC and MAC entities associated to this single split bearer. A further node or function, packet processing function (PPF), which may be separate, or collocated with MgNB or SgNB, also denoted MN or SN, terminates the PDCP protocol on the network side. In this functional split, a centralized unit terminating PDCP may also be called centralized unit (CU) while the remaining nodes implementing the protocol layers below PDCP may be denoted distributed units (DUs). In DC, data units on PDCP may be routed (“split”) via either lower layer or duplicated via both as further described below. From a PDCP point of view the routes via either RLC entity associated with master cell group or RLC entity associated with secondary cell group may also be denoted as transmission paths.

Furthermore, for NR, the carrier aggregation (CA) protocol architecture is specified. In carrier aggregation the UE is connected to one radio node via multiple (e.g. 2) carriers i.e. maintain two physical layers (PHY). Besides this, the protocol stack consists of one MAC, RLC and PDCP. This way, in CA, on MAC, data units to be transmitted may be routed via both carriers. An exception is packet duplication, where the protocol stack entails two RLC logical channels, to which PDCP routes duplicates, and where transmission of each RLC is done one a separate carrier by MAC. In this case, from PDCP point of view routing packets via the different RLC entities associated with the same MAC entity (cell group) may be denoted as different transmission paths.

Embodiments herein relate to communication sessions such as voice calls, wherein the communication session is e.g. a protocol data unit session establishment or a flow establishment for a radio bearer such as a media bearer, at which the decision that e.g. a switch RAT fallback such as EPS Fallback, i.e. change RAT, is needed is taken in a radio network node, i.e. at the first radio network node 12, in an efficient and reliable manner.

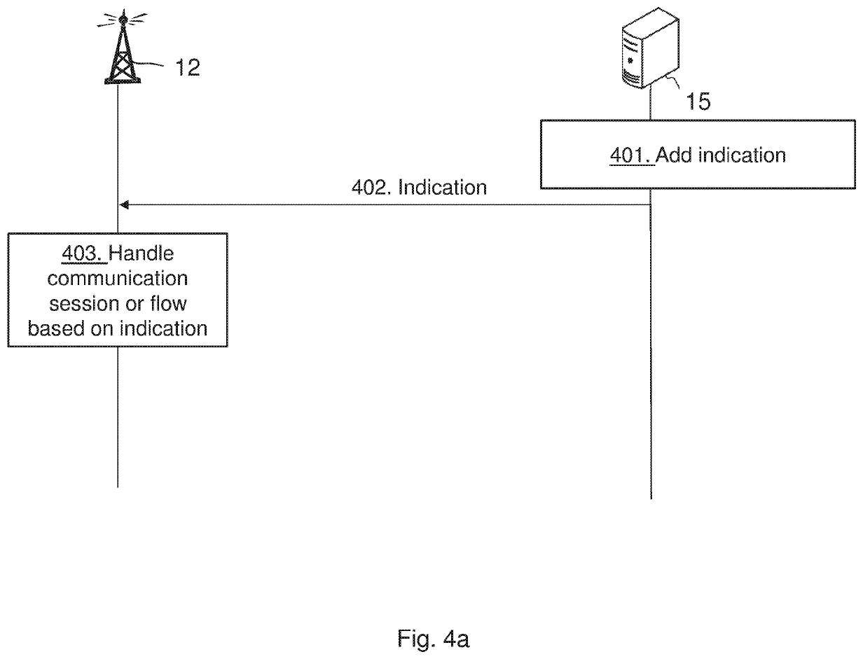

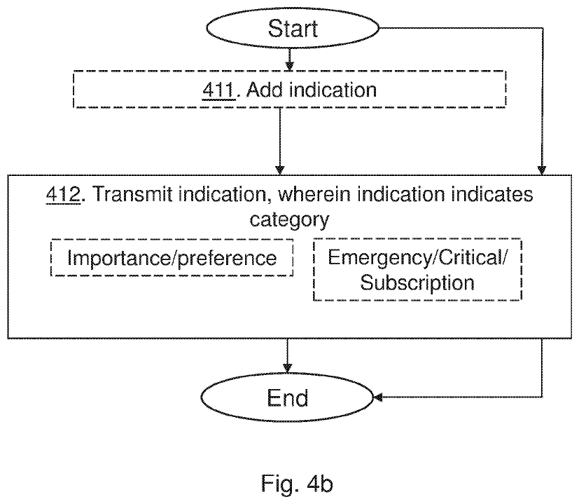

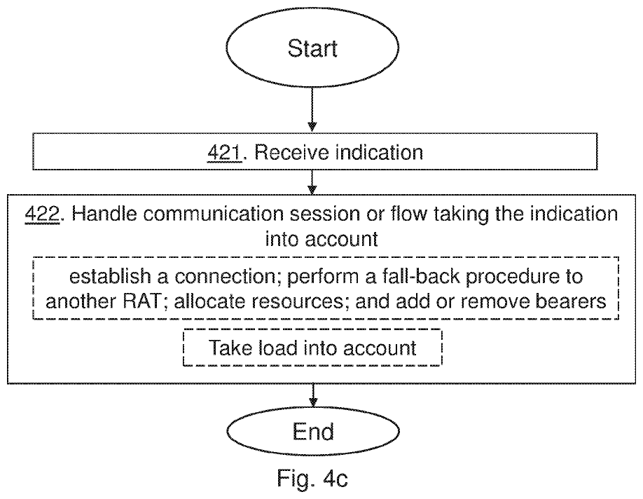

FIG. 4a is a combined flowchart and signalling scheme according to some embodiments herein for controlling transmission of one or more data packets in the wireless communication network.

Action 401. The network node 15 such as an AMF node transmits an indication to the radio network node 12 at a session establishment of the communication session or of at least one flow of the communication session, wherein the indication indicates a category of the communication session or the at least one flow.

Action 402. The radio network node such as the first radio network node 12 receives the indication from the network node 15 at the session establishment of the communication session or of at least one flow of the communication session.

Action 403. The radio network node may then handle the communication session or the at least one flow taking the indication into account. E.g. the indication may indicate that the communication session or the at least one flow of the communication session is of a category such as an emergency call. The radio network node may then, since an emergency call may need positioning capabilities in the RAN, while supported by the 5G core (5GC) and IP Multimedia Subsystem (IMS), move the communication session or the at least one flow of the communication session to a second RAT such as LTE.

The method actions performed by the network node 15, for handling a communication session or one or more flows of the communication session in the wireless communication network according to embodiments herein will now be described with reference to a flowchart depicted in FIG. 4b. The actions do not have to be taken in the order stated below, but may be taken in any suitable order. Actions performed in some embodiments are marked with dashed boxes.

Action 411. The network node 15 may add the indication into a message relating to communication session setup e.g. upon a condition fulfilled such as being an emergency call or similar.

Action 412. The network node 15 transmits the indication to the radio network node 12 at a session establishment of the communication session or of at least one flow of the communication session, wherein the indication indicates the category of the communication session or the at least one flow. The category may be associated with an importance at the radio network node 12, a preference of an operator or a preconfigured manner. The category may thus be a value indicating a preconfigured group or type of the communication session or the at least one flow e.g. an emergency call. For example, the indicated category may define whether the communication session or the at least one flow is related to an emergency service, a mission critical service or a subscription service. The at least one flow may be a media flow e.g. for a voice call. The indication may be transmitted in a modification request to the radio network node 12. The indicated category may define a class of importance, and the session establishment may be a flow establishment or a protocol data unit session establishment.

The method actions performed by the radio network node 12 for handling a communication session or one or more flows of the communication session in the wireless communication network 1 according to embodiments herein will now be described with reference to a flowchart depicted in FIG. 4c. The actions do not have to be taken in the order stated below, but may be taken in any suitable order. Actions performed in some embodiments are marked with dashed boxes.

Action 421. The radio network node 12 receives the indication from the network node 15 at the session establishment of the communication session or of at least one flow of the communication session. The indication indicates the category of the communication session or the at least one flow. The category may be associated with an importance at the radio network node 12. The indicated category may define whether the communication session or the at least one flow is related to an emergency service, a mission critical service or a level of subscription service e.g. prioritized subscription such as gold, silver, bronze. The indicated category may define a class of importance. The indication may be received in a modification request from the network node 15. The at least one flow may be a media flow. The session establishment may be a flow establishment or a protocol data unit session establishment.

Action 422. The radio network node 12 further handles the communication session or the at least one flow taking the indication into account. E.g. the radio network node 12 may perform one or more of the following: establish a connection to a user equipment of the communication session taking the indication into account; perform a fall-back procedure to another radio access technology taking the indication into account; allocate resources taking the indication into account; and add or remove bearers taking the indication into account. The radio network node 12 may further handle the communication session or the at least one flow the communication session by further taking load at the radio network node 12 into account.

Embodiments herein enable the RAN i.e. the radio network node to be aware of the category such as priority importance at the QoS flow establishment with correct priority, i.e. not purely based on the ARP PriorityLevel as it only tells the relative priority and not explicitly states if the call is an emergency call for example.

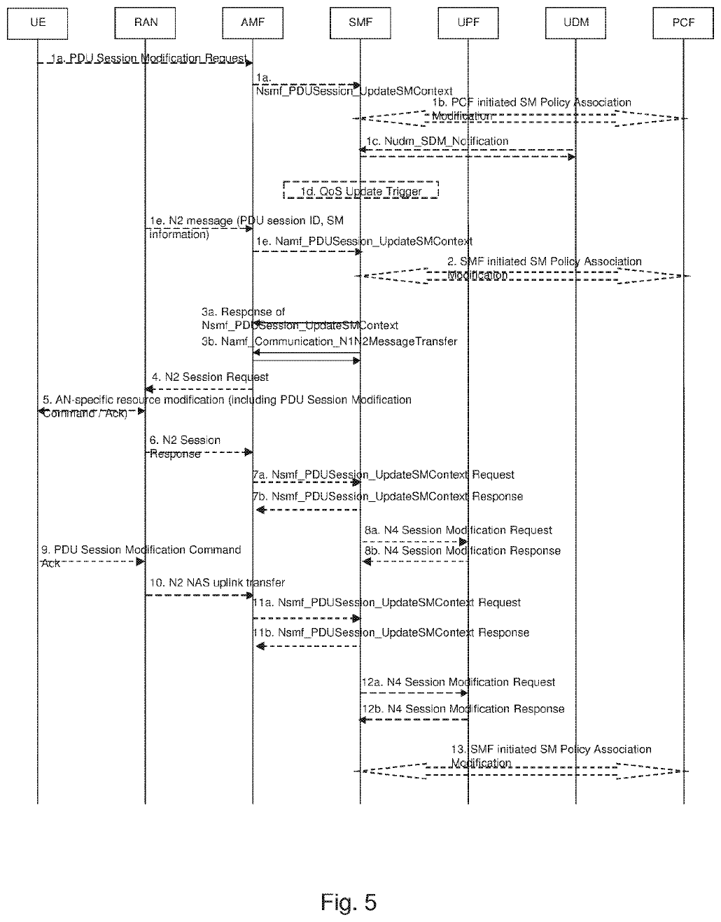

The UE 10 or a network node requested PDU Session Modification procedure (non-roaming and roaming with local breakout scenario) is depicted in FIG. 5. In this example the network node 15 is an AMF node and the radio network node 12 is a RAN node.

Action 1. The procedure may be triggered by following events:

Action 1a. (UE initiated modification) The UE initiates the PDU Session Modification procedure by the transmission of a non-access stratum (NAS) message (N1 SM container (PDU Session Modification Request (PDU session ID, Packet Filters, Operation, Requested QoS, Segregation, 5GSM Core Network Capability)), PDU Session ID) message. Depending on the Access Type, if the UE was in connection management (CM)-IDLE state, this SM-NAS message is preceded by the Service Request procedure. The NAS message is forwarded by the (R)AN to the AMF node with an indication of User location Information. The AMF node invokes Nsmf_PDUSession_UpdateSMContext, e.g. PDU Session ID, N1 SM container (PDU Session Modification Request).

When the UE requests specific QoS handling for selected service data flows (SDF), the PDU Session Modification Request includes Packet Filters describing the SDF(s), the requested Packet Filter Operation (e.g. add, modify, delete) on the indicated Packet Filters, the Requested QoS and optionally a Segregation indication. The Segregation indication is included when the UE recommends to the network to bind the applicable SDF(s) on a distinct and dedicated QoS Flow e.g. even if an existing QoS Flow can support the requested QoS. The network should abide by the UE request, but is allowed to proceed instead with binding the selected SDF(s) on an existing QoS Flow.

Only one QoS Flow may be used for traffic segregation. If UE makes subsequent requests for segregation of additional SDF(s), the additional SDF(s) are multiplexed on the existing QoS Flow that is used for segregation.

The UE 10 may not trigger a PDU Session Modification procedure for a PDU Session corresponding to a Local Area Data Network (LADN) when the UE is outside the area of availability of the LADN.

The PS Data Off status, if changed, shall be included in the Protocol Configuration Option (PCO) in the PDU Session Modification Request message.

When policy control function (PCF) is deployed, the SMF shall further report the PS Data Off status to PCF if the PS Data Off event trigger is provisioned, the additional behaviour of SMF and PCF for 3GPP PS Data Off is defined in TS 23.503 [20].

The 5GSM Core Network Capability is provided by the UE and handled by SMF as defined in TS 23.501 [2] clause 5.4.4b.

Action 1b. (SMF requested modification) The PCF performs a PCF initiated SM Policy Association Modification procedure as defined in clause 4.16.5.2 in TS 23.502 to notify SMF about the modification of policies. This may e.g.; have been triggered by a policy decision or upon AF requests, e.g. Application Function influence on traffic routing as described in action 5 in clause 4.3.6.2 in TS 23.502.

Action 1c. (SMF requested modification) The UDM updates the subscription data of SMF by Nudm_SDM_Notification comprising SUPI, Session Management Subscription Data. The SMF updates the Session Management Subscription Data and acknowledges the UDM by returning an Ack with identifier (SUPI).

Action 1d. (SMF requested modification) The SMF may decide to modify PDU Session. This procedure also may be triggered based on locally configured policy or triggered from the (R)AN (see clause 4.2.6 in TS 23.502).

If the SMF receives one of the triggers in action 1b-1d, the SMF starts SMF requested PDU Session Modification procedure.

Action 1e. (AN initiated modification) (R)AN shall indicate to the SMF when the AN resources onto which a QoS Flow is mapped are released irrespective of whether notification control is configured. (R)AN sends the N2 message (PDU Session ID, N2 SM information) to the AMF node. The N2 SM information includes the QFI, User location Information and an indication that the QoS Flow is released. The AMF node invokes Nsmf_PDUSession_UpdateSMContext (N2 SM information).

(AN initiated notification control) In case notification control is configured for a GBR Flow, (R)AN sends a N2 message (PDU Session ID, N2 SM information) to SMF when the (R)AN decides the QoS targets of the QoS Flow cannot be fulfilled or can be fulfilled again, respectively. The N2 SM information includes the QFI and an indication that the QoS targets for that QoS Flow cannot be fulfilled or can be fulfilled again, respectively. The AMF node invokes Nsmf_PDUSession_UpdateSMContext (N2 SM information). If the PCF has subscribed to the event, SMF reports this event to the PCF for each PCC Rule for which notification control is set, see action 2. Alternatively, if dynamic PCC does not apply for this DNN, and dependent on locally configured policy, the SMF may start SMF requested PDU Session Modification procedure, see action 3b.

Action 2. The SMF may need to report some subscribed event to the PCF by performing an SMF initiated SM Policy Association Modification procedure as defined in clause 4.16.5.1. This step may be skipped if PDU Session Modification procedure is triggered by action 1b or 1d. If dynamic PCC is not deployed, the SMF may apply local policy to decide whether to change the QoS profile.

Actions 3 to 7 are not invoked when the PDU Session Modification requires only action at a user plane function (UPF), e.g. gating.

Action 3a. For UE or AN initiated modification, the SMF responds to the AMF node through Nsmf_PDUSession_UpdateSMContext (N2 SM information (PDU Session ID, QFI(s), QoS Profile(s), Session-AMBR), N1 SM container (PDU Session Modification Command (PDU Session ID, QoS rule(s), QoS rule operation, QoS Flow level QoS parameters if needed for the QoS Flow(s) associated with the QoS rule(s), Session-AMBR))). See TS 23.501 [2] clause 5.7 for the QoS Profile, and QoS rule and QoS Flow level QoS parameters.

The N2 SM information carries information that the AMF node shall provide to the (R)AN. It may include the QoS profiles and the corresponding QFIs to notify the (R)AN that one or more QoS flows were added, or modified. It may include only QFI(s) to notify the (R)AN that one or more QoS flows were removed. If the PDU Session Modification was triggered by the (R)AN Release in action 1e the N2 SM information carries an acknowledgement of the (R)AN Release. If the PDU Session Modification was requested by the UE for a PDU Session that has no established User Plane resources, the N2 SM information provided to the (R)AN includes information for establishment of User Plane resources.

The N1 SM container carries the PDU Session Modification Command that the AMF node shall provide to the UE. It may include the QoS rules, QoS Flow level QoS parameters if needed for the QoS Flow(s) associated with the QoS rule(s) and corresponding QoS rule operation and QoS Flow level QoS parameters operation to notify the UE that one or more QoS rules were added, removed or modified.

Action 3b. For SMF requested modification, the SMF invokes Namf_Communication_N1N2MessageTransfer (N2 SM information (PDU Session ID, QFI(s), QoS Profile(s), Session-AMBR), N1 SM container (PDU Session Modification Command (PDU Session ID, QoS rule(s), QoS Flow level QoS parameters if needed for the QoS Flow(s) associated with the QoS rule(s), QoS rule operation and QoS Flow level QoS parameters operation, Session-AMBR))).

If the UE is in CM-IDLE state and an ATC is activated, the AMF node updates and stores the UE context based on the Namf_Communication_N1N2MessageTransfer and actions 4, 5, 6 and 7 are skipped. When the UE is reachable e.g. when the UE enters CM-CONNECTED state, the AMF node forwards the N1 message to synchronize the UE context with the UE.

Action 4. The AMF node may send a request such as a N2 PDU Session Request (N2 SM information received from SMF, NAS message (PDU Session ID, N1 SM container (PDU Session Modification Command))) Message to the (R)AN node. The request may comprise the indication indicating the category according to embodiments herein.

Action 5. The (R)AN may issue AN specific signalling exchange with the UE that is related with the information received from SMF. For example, in case of a NG-RAN, an RRC Connection Reconfiguration may take place with the UE modifying the necessary (R)AN resources related to the PDU Session.

Action 6. The (R)AN may acknowledge N2 PDU Session Request by sending a N2 PDU Session Ack (N2 SM information (List of accepted/rejected QFI(s), AN Tunnel Info, PDU Session ID), User location Information) Message to the AMF node. In case of Dual Connectivity, if one or more QFIs were added to the PDU Session, the Master RAN node may assign one or more of these QFIs to a NG-RAN node which was not involved in the PDU Session earlier. In this case the AN Tunnel Info includes a new N3 tunnel endpoint for QFIs assigned to the new NG-RAN node. Correspondingly, if one or more QFIs were removed from the PDU Session, a (R)AN node may no longer be involved in the PDU Session anymore, and the corresponding tunnel endpoint is removed from the AN Tunnel Info. The NG-RAN may reject QFI(s) if it cannot fulfill the User Plane Security Enforcement information for a corresponding QoS Profile, e.g. due to the UE Integrity Protection Maximum Data Rate being exceeded.

Action 7. The AMF node forwards the N2 SM information and the User location Information received from the AN to the SMF via Nsmf_PDUSession_UpdateSMContext service operation. The SMF replies with a Nsmf_PDUSession_UpdateSMContext Response.

If the (R)AN rejects QFI(s) the SMF is responsible of updating the QoS rules and QoS Flow level QoS parameters if needed for the QoS Flow(s) associated with the QoS rule(s) in the UE accordingly.

Action 8. The SMF may update N4 session of the UPF(s) that are involved by the PDU Session Modification by sending N4 Session Modification Request message to the UPF. (see NOTE 2)

Action 9. The UE acknowledges the PDU Session Modification Command by sending a NAS message comprising a PDU Session ID, an N1 SM container (PDU Session Modification Command Ack) message.

Action 10. The (R)AN forwards the NAS message to the AMF node.

Action 11. The AMF node forwards the N1 SM container (PDU Session Modification Command Ack) and User Location Information received from the AN to the SMF via Nsmf_PDUSession_UpdateSMContext service operation. The SMF replies with a Nsmf_PDUSession_UpdateSMContext Response.

Action 12. The SMF may update N4 session of the UPF(s) that are involved by the PDU Session Modification by sending N4 Session Modification Request (N4 Session ID) message to the UPF. For a PDU Session of Ethernet PDU Session Type, the SMF may notify the UPF to add or remove Ethernet Packet Filter Set(s) and forwarding rule(s).

NOTE 2: The UPFs that are impacted in the PDU Session Modification procedure depends on the modified QoS parameters and on the deployment. For example in case of the session AMBR of a PDU Session with an UL CL changes, only the UL CL is involved. This note also applies to the action 8.

Action 13. If the SMF interacted with the PCF in action 1b or 2, the SMF notifies the PCF whether the PCC decision could be enforced or not by performing an SMF initiated SM Policy Association Modification procedure as defined in clause 4.16.5.1.

SMF notifies any entity that has subscribed to User Location Information related with PDU Session change.

If action 1b is triggered to perform Application Function influence on traffic routing by action 5 in clause 4.3.6.2, the SMF may reconfigure the User Plane of the PDU Session as described in action 6 in clause 4.3.6.2.

For emergency calls the AMF node knows based on the request type in the Request Type IE in the PDU Session Establishment Request (TS 23.502 4.3.2.2)

4.3.2.2 UE Requested PDU Session Establishment

4.3.2.2.1 Non-roaming and Roaming with Local Breakout

Step 1

From UE to AMF node: NAS Message (S-NSSAI(s), DNN, PDU Session ID, Request type, Old PDU Session ID, N1 SM container (PDU Session Establishment Request)).

When Emergency service is required and an Emergency PDU Session is not already established, a UE shall initiate the UE Requested PDU Session Establishment procedure with a Request Type indicating “Emergency Request”.

The AMF node knows the MPS status from the Registration procedure based on subscription information and interaction with UDM.

General Registration

Action 14a-c: “If the UE is subscribed to MPS in the serving public land mobile network (PLMN), “MPS priority” is included in the Access and Mobility Subscription data provided to the AMF node.”

In action 4 (marked underlined) the QoS flow establishment reaches the NG-RAN i.e. the radio network node. According to embodiments herein the network node 15 such as the AMF node includes the indication indicating category e.g. an indication of the priority importance at the QoS flow establishment. In the PDU Session Resource Modification Request (TS 38.413 9.2.1.5) in the IE PDU Session Resource Modify Request Transfer (TS 38.413 9.3.4.3) the IE QoS Flow Level QoS Parameters (TS 38.413 9.1.12) exists. In this IE a Priority Indication parameter, see underlined, may be added to indicate the category according to embodiments herein. See below.

TS 38.413 9.3.1.12 QoS Flow Level QoS Parameters

| | | | IE type and | |
|---|---|---|---|---|
| IE/Group Name | Presence | Range | reference | Semantics description |
| CHOICE QoS | M | | | |
| Characteristics | | | | |
| >Non-dynamic 5QI | | | | |
| >>Non Dynamic 5QI | M | | 9.3.1.28 | |
| Descriptor | | | | |
| >Dynamic 5QI | | | | |
| >>Dynamic 5QI | M | | 9.3.1.18 | |
| Descriptor | | | | |
| Allocation and | M | | 9.3.1.19 | |
| Retention Priority | | | | |
| GBR QoS Flow | O | | 9.3.1.10 | This IE shall be present |
| Information | | | | for GBR QoS Flows only. |
| Reflective QoS | O | | ENUMERATED | Details in TS 23.501 [9]. |
| Attribute | | | (subject | This IE may be present |
| | | | to, . . . ) | in case of non-GBR QoS |
| | | | | flows and shall be |
| | | | | ignored otherwise. |
| Additional QoS Flow | O | | ENUMERATED | This IE indicates that |
| Information | | | (more | traffic for this QoS flow is |
| | | | likely, . . . ) | likely to appear more |
| | | | | often than traffic for other |
| | | | | flows established for the |
| | | | | PDU session. |
| | | | | This IE may be present |
| | | | | in case of non-GBR QoS |
| | | | | flows and shall be |
| | | | | ignored otherwise. |
| Priority Indication | O | | ENUMERATED | This IE indicates that |
| | | | (Emergency, | traffic for this QoS flow |
| | | | MPS/WPS, . . . ) | is of a category e.g. a |
| | | | | type prioritized as |
| | | | | indicated. |

Embodiments herein provide a manner of indicating to the radio network node 12 the category, e.g. emergency, subscription, critical, of the flow or session in an efficient manner. The radio network node 12 may then handle the flow and/or session in a proper manner based on the indication.

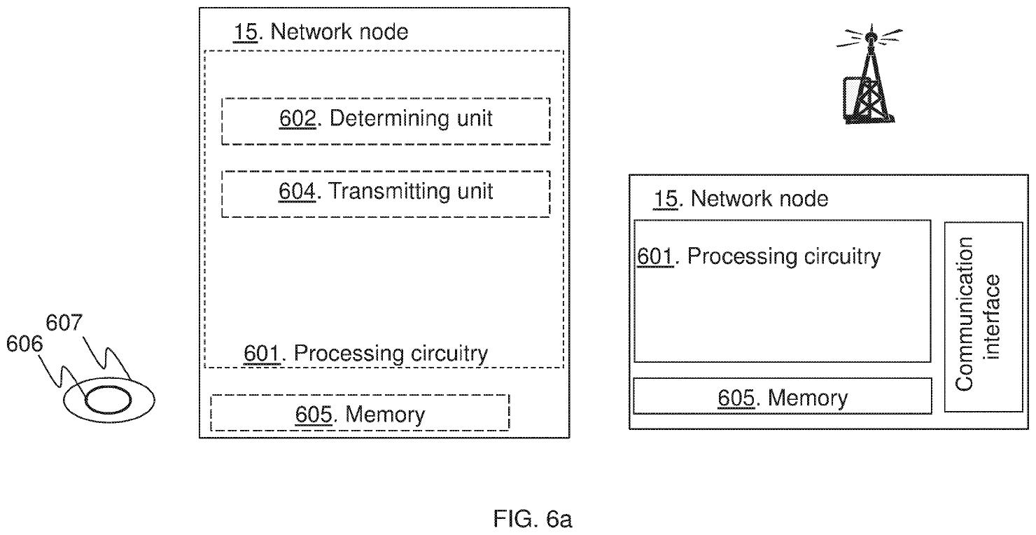

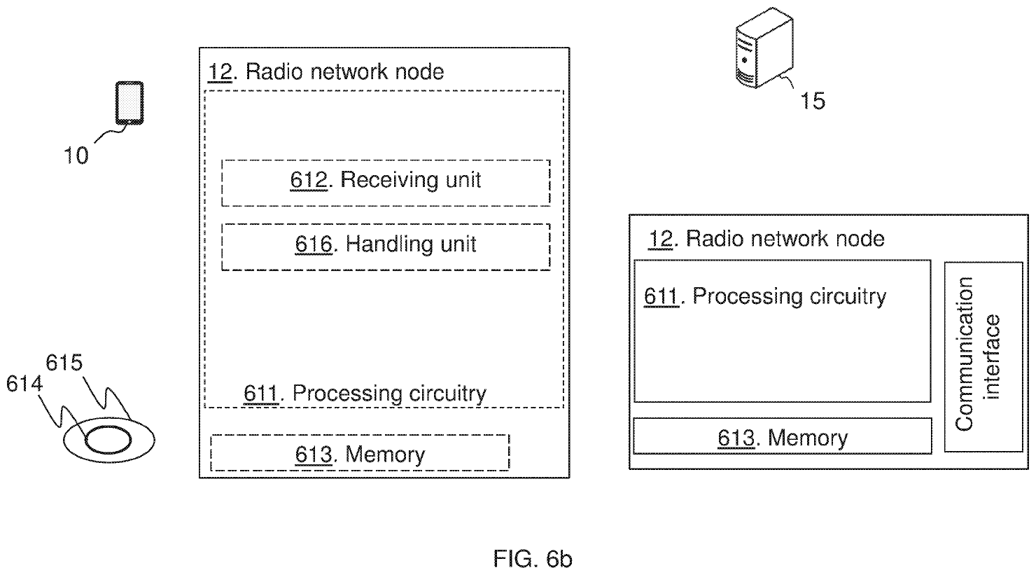

FIG. 6a is a block diagram depicting the network node 15 for handling a communication session or one or more flows of the communication session in a wireless communication network 1 according to embodiments herein.

The network node 15 may comprise processing circuitry 601, e.g. one or more processors, configured to perform the methods herein.

The network node 15 comprises a determining unit 602. The network node 15, the processing circuitry 601 and/or the determining unit 602 may be configured to determine category of the flow and/or session. The network node 15 comprises a transmitting unit 604, e.g. a transmitter or a transceiver or module. The network node 15, the processing circuitry 601 and/or the transmitting unit is configured to transmit the indication to the radio network node 12 at a session establishment of the communication session or of at least one flow of the communication session. The indication indicates the category of the communication session or the at least one flow. The category may be associated with an importance at the radio network node, a preference of an operator or a preconfigured manner. The indication may be transmitted in a modification request to the radio network node. The indicated category may be defining whether the communication session or the at least one flow is related to an emergency service, a mission critical service or a subscription service. The indicated category may be defining a class of importance. The session establishment may be a flow establishment or a protocol data unit session establishment.

The network node 15 further comprises a memory 605. The memory comprises one or more units to be used to store data on, such as categories, indications, requests, responses, applications to perform the methods disclosed herein when being executed, and similar. Furthermore, the network node may comprise a communication interface such as comprising a transmitter, a receiver and/or a transceiver and/or one or more antennas.

The methods according to the embodiments described herein for the network node are respectively implemented by means of e.g. a computer program product 606 or a computer program, comprising instructions, i.e., software code portions, which, when executed on at least one processor, cause the at least one processor to carry out the actions described herein, as performed by the network node 15. The computer program product 606 may be stored on a computer-readable storage medium 607, e.g. a disc, a universal serial bus (USB) stick or similar. The computer-readable storage medium 607, having stored thereon the computer program product, may comprise the instructions which, when executed on at least one processor, cause the at least one processor to carry out the actions described herein, as performed by the network node 15. In some embodiments, the computer-readable storage medium may be a transitory or a non-transitory computer-readable storage medium. Thus, embodiments herein may disclose a network node for controlling transmission of one or more data packets in a wireless communication network, wherein the network node comprises processing circuitry and a memory, said memory comprising instructions executable by said processing circuitry whereby said network node is operative to to perform any of the methods herein.

FIG. 6a is a block diagram depicting the radio network node 12 for handling a communication session or one or more flows of the communication session in the wireless communication network 1 according to embodiments herein.

The radio network node 12 may comprise processing circuitry 611, e.g. one or more processors, configured to perform the methods herein.

The radio network node 12 comprises a receiving unit 612, e.g. a receiver or a transceiver or module. The radio network node 12, the processing circuitry 611, and/or the receiving unit 612 is configured to receive the indication from the network node 15 at a session establishment of the communication session or of at least one flow of the communication session, wherein the indication indicates the category of the communication session or the at least one flow. The category may be associated with an importance at the radio network node 12. The indication may be received in a modification request from the network node 15. The indicated category may be defining whether the communication session or the at least one flow is related to an emergency service, a mission critical service or a subscription service. The indicated category may be defining a class of importance. The session establishment may be a flow establishment or a protocol data unit session establishment.

The radio network node 12 comprises a handling unit 616. The radio network node 12, the processing circuitry 611, and/or the handling unit 616 is configured to handle the communication session or the at least one flow taking the indication into account. E.g. the radio network node 12, the processing circuitry 611, and/or the handling unit 616 may be configured to perform one or more of the following: establish a connection to a user equipment of the communication session taking the indication into account; perform a fall-back procedure to another radio access technology taking the indication into account; allocate resources taking the indication into account; and add or remove bearers taking the indication into account. The radio network node 12, the processing circuitry 611, and/or the handling unit 616 may further be configured to handle the communication session or the at least one flow by further taking load at the radio network node into account.

The radio network node 12 further comprises a memory 613. The memory comprises one or more units to be used to store data on, such as data packets, indications, radio resources, priority classes, categories, applications to perform the methods disclosed herein when being executed, and similar. Furthermore, the radio network node 12 may comprise a communication interface such as comprising a transmitter, a receiver, a transceiver, an Xn interface, and/or one or more antennas.

The methods according to the embodiments described herein for the radio network node 12 are respectively implemented by means of e.g. a computer program product 614 or a computer program, comprising instructions, i.e., software code portions, which, when executed on at least one processor, cause the at least one processor to carry out the actions described herein, as performed by the radio network node 12. The computer program product 614 may be stored on a computer-readable storage medium 615, e.g. a disc, a universal serial bus (USB) stick or similar. The computer-readable storage medium 615, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose a radio network node 12, wherein the radio network node 12 comprises processing circuitry and a memory, said memory comprising instructions executable by said processing circuitry whereby said radio network node 12 is operative to to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

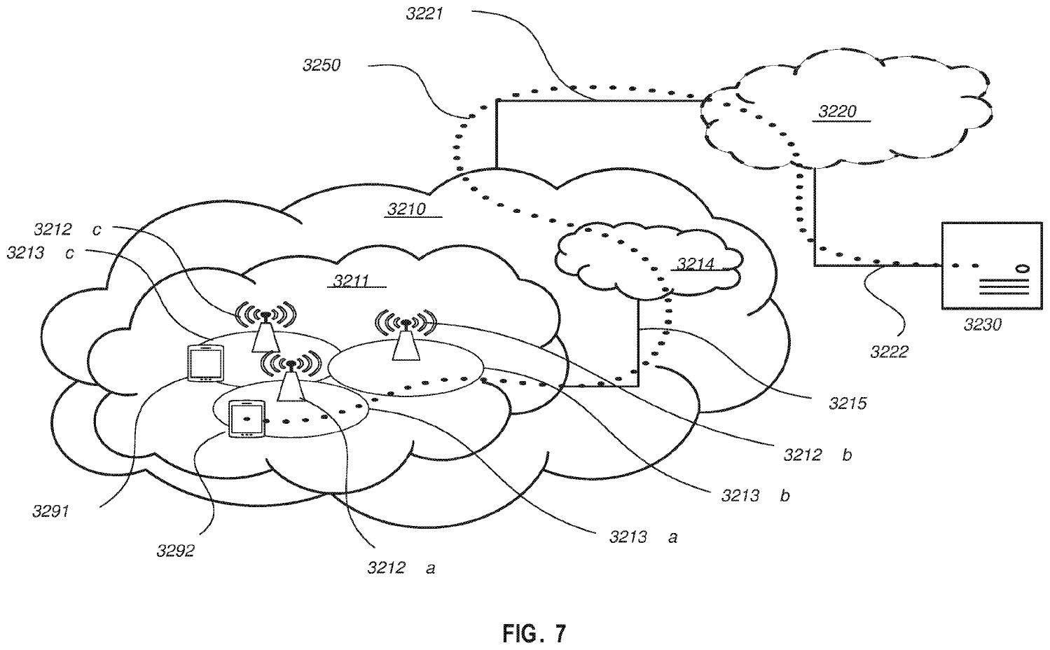

FIG. 7 shows a Telecommunication network connected via an intermediate network to a host computer in accordance with some embodiments. With reference to FIG. 7, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the UE 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 7 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

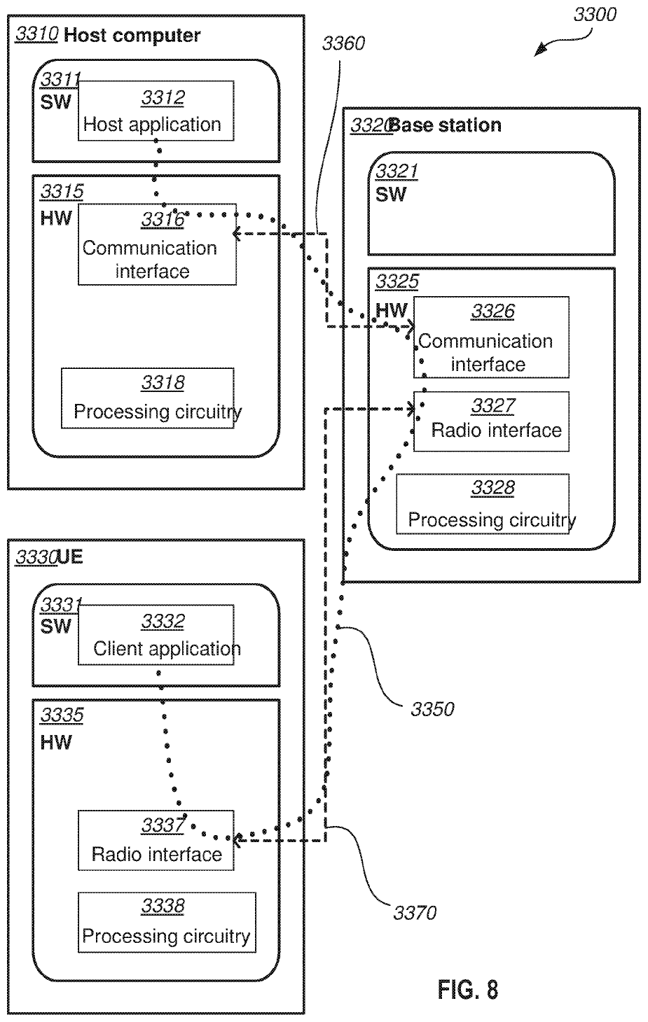

FIG. 8: Host computer communicating via a base station with a user equipment over a partially wireless connection in accordance with some embodiments

Example implementations, in accordance with an embodiment, of the UE, base station and host computer discussed in the preceding paragraphs will now be described with reference to FIG. 8. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 8) served by base station 3320. Communication interface 3326 may be configured to facilitate connection 3360 to host computer 3310. Connection 3360 may be direct or it may pass through a core network (not shown in FIG. 8) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 8 may be similar or identical to host computer 3230, one of base stations 3212a, 3212b, 3212c and one of UEs 3291, 3292 of FIG. 7, respectively. This is to say, the inner workings of these entities may be as shown in FIG. 8 and independently, the surrounding network topology may be that of FIG. 7.

In FIG. 8, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency since handling of certain communication sessions such as emergency calls is efficiently handled and thereby provide benefits such as reduced waiting time and better responsiveness.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

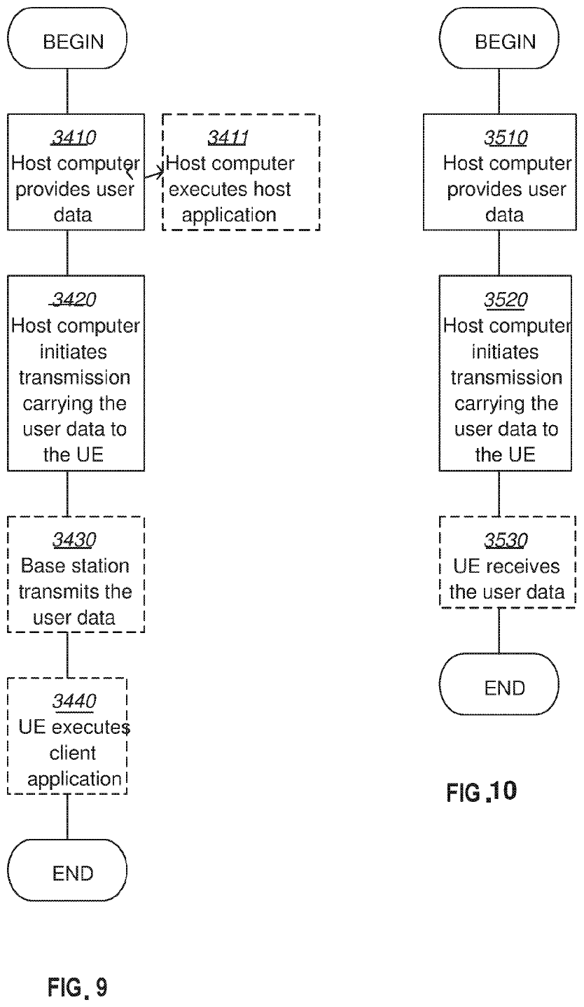

FIG. 9: Methods implemented in a communication system including a host computer, a base station and a user equipment in accordance with some embodiments.

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 10: Methods implemented in a communication system including a host computer, a base station and a user equipment in accordance with some embodiments.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

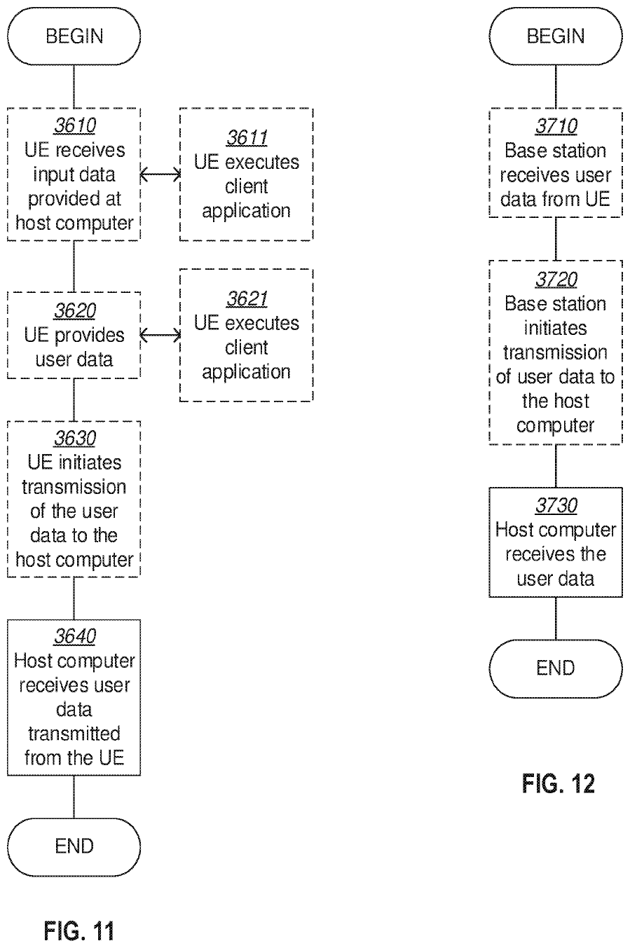

FIG. 11: Methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 12: Methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### Abbreviation Explanation

### NR New Radio

### 3GPP 3rd Generation Partnership Project

### TS Technical Specification

### UE User Equipment

### LTE Long Term Evolution

### DC Dual Connectivity

### PDCP Packet Data Convergence Protocol

### RLC Radio Link Controller

### PHY Physical Layer

gNB g-Node-B

### MN Master Node

### SN Secondary Node

### CU Centralized Unit

### DU Distributed Unit

### CA Carrier Aggregation

### MAC Medium Access Protocol

### URLLC Ultra-Reliable Low Latency

### DRB Data Radio Bearer

### PDU Protocol Data Unit

### LCID Logical Channel ID

### CE Control Element

1. A method performed by a network node for handling a communication session or one or more flows of the communication session in a wireless communication network, the method comprising:
transmitting an indication to a radio network node at a session establishment of the communication session or of at least one flow of the communication session, wherein the indication indicates a category of the communication session or the at least one flow.

2. The method according to claim 1, wherein the category is associated with an importance at the radio network node, a preference of an operator or a preconfigured manner.

3. The method according to claim 1, wherein the indication is transmitted in a modification request to the radio network node.

4. The method according to claim 1, wherein the indicated category is defining whether the communication session or the at least one flow is related to an emergency service, a mission critical service or a level of subscription service.

5. The method according to claim 1, wherein the indicated category is defining a class of importance.

6. The method according to claim 1, wherein the session establishment is a flow establishment or a protocol data unit session establishment.

7. A method performed by a radio network node for handling a communication session or one or more flows of the communication session in a wireless communication network, the method comprising:
receiving an indication from a network node at a session establishment of the communication session or of at least one flow of the communication session, wherein the indication indicates a category of the communication session or the at least one flow; and
handling the communication session or the at least one flow taking the indication into account.

8. (canceled)

9. The method according to claim 7, wherein handling comprises one or more of the following: establish a connection to a user equipment of the communication session taking the indication into account; perform a fall-back procedure to another radio access technology taking the indication into account; allocate resources taking the indication into account; and add or remove bearers taking the indication into account.

10. The method according to claim 7, wherein handling the communication session or the at least one flow further takes load at the radio network node into account.

11. The method according to claim 7, wherein the indication is received in a modification request from the network node.

12. The method according to claim 7, wherein the indicated category is defining whether the communication session or the at least one flow is related to an emergency service, a mission critical service or a subscription service.

13. The method according to claim 7, wherein the indicated category is defining a class of importance.

14. The method according to claim 7, wherein the session establishment is a flow establishment or a protocol data unit session establishment.

15. A network node for handling a communication session or one or more flows of the communication session in a wireless communication network, wherein the network node is configured to:
transmit an indication to a radio network node at a session establishment of the communication session or of at least one flow of the communication session, wherein the indication indicates a category of the communication session or the at least one flow.

16-20. (canceled)

21. A radio network node for handling a communication session or one or more flows of the communication session in a wireless communication network, wherein the radio network node is configured to:
receive an indication from a network node at a session establishment of the communication session or of at least one flow of the communication session, wherein the indication indicates a category of the communication session or the at least one flow; and to
handle the communication session or the at least one flow taking the indication into account.

22. The radio network node according to claim 21, wherein the category is associated with an importance at the radio network node.

23. The radio network node according to claim 21, wherein the radio network node is configured to handle the communication session or the at least one flow by performing one or more of the following: establish a connection to a user equipment of the communication session taking the indication into account; perform a fall-back procedure to another radio access technology taking the indication into account; allocate resources taking the indication into account; and add or remove bearers taking the indication into account.

24. The radio network node according to claim 21, wherein the radio network node is configured to handle the communication session or the at least one flow by further taking load at the radio network node into account.

25. The radio network node according to claim 21, wherein the indication is received in a modification request from the network node.

26. The radio network node according to claim 21, wherein the indicated category is defining whether the communication session or the at least one flow is related to an emergency service, a mission critical service or a subscription service.

27. The radio network node according to claim 21, wherein the indicated category is defining a class of importance.

28. The radio network node according to claim 21, wherein the session establishment is a flow establishment or a protocol data unit session establishment.

29. (canceled)

30. (canceled)
